(19) United States
(12) Patent Application Publication
(10) Pub. No.: US 2005/0073696 A1
(43) Pub. Date: Apr. 7, 2005

(54) Duplex printing

(76) Inventors: Andrew Mackenzie, Barcelona (ES); Albert Serra, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/677,863

(22) Filed: Oct. 1, 2003

(51) Int. Cl. G06F 15/00

(52) U.S. Cl. 358/1.6

(57) ABSTRACT

A method of printing double sided documents on a printer device, said method comprising: formatting said document into a form suitable for printing onto first sides of a plurality of media sheets in a single operation; generating a set of user instructions for instructing a human user to manipulate said plurality of media sheets and enter said sheets into said printer device; and printing said set of user instructions.

### FIELD OF THE INVENTION

The present invention relates to the field of printing, and particularly although not exclusively, to printing on two sides of a print media.

### BACKGROUND TO THE INVENTION

It is known for commercial printer devices of the computer peripheral type aimed at mid-market customers such as small businesses, professional practices and the like to be able to print double sided onto two sides of a print media automatically. For example, a document may be printed from a word processing application onto sheets of A4 paper or US letter sized paper using both sides of each sheet of paper, to produce a double-sided report. Each sheet of paper may be printed on both sides, automatically by the known printer device.

Many less expensive known printer models do not have an automatic duplex mechanism installed. However, these known printer devices have a software facility which runs on a host computer and which drives the printer to allow manual duplexing. The software application presents screen viewable instructions to a user. In the known printing systems, a wad of sheets are printed on a first side, with a first set of pages, for example odd numbered pages 1, 3, 5, 7 . . . . The software package then presents a screen display giving instructions to the user to remove the wad of printed sheets from the printer, and reintroduce them into the printer's manual feed tray in a different orientation. The user removes the wad of sheets, follows the instructions for orienting the sheets of paper, and feeds the wad of sheets back into the manual feed tray of the printer device. The user then activates the printer to perform a second run of printing, in which a second set of pages, for example even numbered pages 2, 4, 6, 8 . . . are printed on the reverse sides of the sheets, giving two sided printing.

Consequently, in the known printer devices having manual duplexing assisted by a software package running on a host computer, there are three basic operations. Firstly, printing of a first set of (odd numbered) pages on first sides of a wad of sheets of paper. Secondly, removal of the printed sheets from an output tray of the printer, and manual reorientation of those sheets according to instructions displayed on a visual display interface on the computers screen, resulting in manual feeding of the printed wad into an input tray of the printer; and thirdly, printing of a second set of pages (even numbered pages) on the reverse sides of the sheets, to produce the final double sided printed document.

Referring to FIG. 1 herein, there is illustrated schematically a first screen display presented by a known printer software package for setting printing properties for printing a two sided document in book format. A user can select an orientation of the print media, either portrait, landscape or mirror image; can select two sided printing in either a book or tablet format, and can select whether multiple pages are to be written on each side of a sheet of print media; and can also select poster printing in a 2×2; 3×3 or 4×4 format; can select a number of copies to be printed; and can select whether or not to start printing from the last page or from the first page of the document.

Referring to FIG. 2 herein, a user, having selected two sided printing is presented with a second display screen 200 which contains user dialogue containing instructions on removal of a stack of printed sheets from an output tray of the printer, reorientation of the stack of printed sheets; and insertion of the stack of sheets pages into an input tray of the printer in order to obtain two sided printing as selected in the first dialogue display.

The known manual two sided printing systems work well, however there are several problems as follows:

There are a number of variables which determine how duplex documents must be manipulated to be printed correctly. Depending on these variables, a pile of sheets of media must be introduced into an input tray of a printer device in one horizontal orientation or another. Depending on the media path followed within a printer, documents must be placed either face up or face down by a user. Due to the need to remove the sheets from the printer device after a first run of printing, and align the sheets manually for good printed results, it is easy for a user to make mistakes and reintroduce the pile of sheets with an incorrect horizontal orientation, or with the incorrect side up in the input tray. Any such errors result in wasted time, media and ink.

Referring to FIG. 3 herein, there is illustrated schematically in table form some different cases for printing of two sided documents, which can be selected using the known manual printing systems.

The orientation of print on a page can either be in portrait form or landscape form.

The binding method may be either “book binding format”, in which binding is nominally placed on a left edge of a sheet of media as it is orientated in a normal reading orientation; or in a “tablet binding format” in which a top edge of the document in a correct reading orientation is designated as a bound edge.

A number of document pages per printed side of sheet media may be as follows:
1-up: as a default condition one document page per side of media is printed
2-up: in this format two document pages are printed per single side of sheet media. In this format, document pages are orientated perpendicular to the normal landscape or portrait orientation in the 1-up case.
4-up: in this format four document pages are printed per side of sheet media. To do so, the document is oriented in the same orientation as the side orientation. This case can be treated in the same way as the 1-up case.

Further complexity can result where other features are used such as posters, or banner printing.

For each case of printing, in the known manually assisted two sided printing systems, there is required a separate display screen showing the orientation of the paper which a user has to feed a wad of sheets back into an input tray of a printing device. However, this can lead to several problems as follows:

Firstly, to obtain accurate printing on the second, reverse sides of the sheets of print media, the stack of media sheets should have all its edges neatly aligned to form a neat stack. Typically, the user will take the stack of media sheets, and tap them on a convenient flat surface such as a desktop, in order to align the edges of the media sheets. The surface used to tap the media sheets is often to the side, or behind the user, and the user can become disoriented as the media sheets are removed away from the printer device. The user can easily forget the orientation, in which the media sheets were removed from the printer, and therefore referring back to the instructions on the visual display may not necessarily assist the user and mistakes can still be made. It is easy for the user to lose track of how the stack of media was originally orientated in the output tray of the printer and hence be confused as to how to reintroduce the stack of media into the input tray in the correct orientation.

Secondly, there is a problem in that the user may not have knowledge of the printer media path configuration.

Referring to FIGS. 4 and 5 herein, there is illustrated schematically a known printer device having a complex media path. The printer device has a first paper tray 400 for storing a supply of blank paper, and a first output tray 401 for receiving paper which is output from a printer mechanism. The printer device also has a second input tray 402 for feeding paper into the printer device, and a second output tray 500 at the rear of the printer device. Paper can be input via the first input tray 400 or the second input tray 402, and can output at the first output tray 401, or at the second output tray 500. Paper received by the second output tray 500 is presented in a different orientation as a sheet of paper directed to the first output tray 401.

Referring to FIG. 6 herein some printers have a “C” shaped media path as shown. Media sheets loaded into an input tray printed side up become turned over in the media path of the printer, so that the reverse side faces upwards and is printed on. If the user has no knowledge of the media path, and makes the mistake of putting the media printed side down instead of printed side up, then the second side of each sheet is printed on top of the first, making the document unreadable whilst leaving one side of the sheets unused. The stack of media is wasted, along with wasted ink and wasted time.

Thirdly, there is a problem where the printer is not near to the users computer. If the printer device is remote, for example in a different room, or within a short walking distance of the computer, then it is difficult for the user to read the user dialogue on the computer's screen to correctly orientated and reload the paper when the user is at the printer device.

Fourthly, there is the feature that in order for the user's computer to show the correct user dialogue to the user at the correct time, then the necessary data processing must be done on the users computer. For example in the windows architecture, this is done via a print processor. However, this means that this processing cannot be offloaded to a network spooler, or the print driver cannot run on the network spooler, as is often desired. Therefore, there is a limitation of which computer entity a printer driver can run on.

### SUMMARY OF THE INVENTION

According to one aspect of the present invention, there is provided a method of printing double sided documents on a printer device, said method comprising: printing at least one first side of at least one media sheet in a single operation; printing a set of user instructions for instructing a user to introduce said at least one media sheet into said printer device; and printing at least one second side of said at least one media sheet.

According to a second aspect of the present invention, there is provided a method of printing double sided documents on a printer device, said method comprising: formatting said document into a form suitable for printing onto first sides of a plurality of media sheets in a single operation; generating a set of user instructions for instructing a human user to manipulate said plurality of media sheets and enter said sheets into said printer device; and printing said set of user instructions.

According to a third aspect of the present invention, there is provided a printing system comprising: a computer entity capable of generating a print job; a printer device for printing a plurality of sheets of print media according to said print job; said printing system operable for: printing first sides of a set of said print media sheets; and printing a set of instructions for entering said set of printed print media sheets into said printer device for printing second sides of said media sheets.

According to a fourth aspect of the present invention, there is provided a print job comprising: a plurality of pages of information arranged in a data format comprising a plurality of first sides and a plurality of second sides; and a user information data, describing instructions to a human user for orientation of a set of media sheets for entry into a printer device.

According to a fifth aspect of the present invention, there is provided program code instructions for controlling a print system, said program code instructions comprising: a component for generating a user instructions, said user instructions specifying an orientation for entering a set of media sheets into an input tray of a printer device; and a component for automatically activating printing of said user instructions along with printing of said media sheets.

According to a sixth aspect of the present invention, there is provided a printed instruction sheet containing a set of instructions advising a human user on orientation of a stack of print media, for entering said stack of print media into an input tray of a printer device.

According to a seventh aspect of the present invention, there is provided a printing system operable for: printing first sides of a set of print media sheets; and printing a set of instructions for entering said set of printed print media sheets into a printer device for printing second sides of said media sheets.

According to an eighth aspect of the present invention, there is provided a method for printing two sided documents, said method comprising: formatting a plurality of document pages in a form suitable for printing on a plurality of sheets of print media; printing first sides of said plurality of sheet media with said document; printing instructions for handling of said plurality of sheets of media; manipulating said plurality of sheets of media in accordance with said set of printed instructions; placing said set of media sheets into an input tray of a printer device; and printing second sides of said plurality of media sheets with said document.

According to a ninth aspect of the present invention, there is provided a method of sending a print job for double sided printing on a printer device, said method comprising: sending an DUPLEX ON instruction signal to said printer device, indicating a duplex printing mode; sending a user instruction for instructing a user to manipulate at least one media sheet at said printer device; and sending a document file to said printer device for printing.

According to a tenth aspect of the present invention, there is provided a method of printing a received print job for double sided printing of a document on a printer device, said method comprising: receiving a document file at said printer device, said document file comprising a set of consecutive pages; receiving a DUPLEX ON instruction signal at said printer device, instructing said printer device to adopt an interrupted printing mode for printing said a document; in response to said DUPLEX ON instruction printing a first set of pages of said document on first sides of said media sheets; receiving a user instruction for instructing a user to manipulate at least one media sheet at said printer device; printing said user instructions on at least one media sheet; and printing a second set of pages of said document on second sides of said media sheets, said second set of sides being alternating with said first set of sides.

Other aspects of the invention are as detailed in the claims herein.

### BRIEF DESCRIPTION OF THE DRAWINGS

For a better understanding of the invention and to show how the same may be carried into effect, there will now be described by way of example only, specific embodiments, methods and processes with reference to the accompanying drawings in which:

FIG. 1 illustrates schematically a known ‘layout view’ interface display generated by a known printer driver, offering selections of media sheet orientation, one or two sided printing and multiple printed pages per sheet to a user of a computer entity hosting the printer driver;

FIG. 2 illustrates schematically a known ‘user dialogue’ display of the known printer driver, giving visual instructions in text and graphics format for orientation of a stack of media sheets for entry into an input tray of a printer device;

FIG. 3 illustrates schematically a table of variable parameters present in deciding on how to print a document on a known printer device;

FIG. 4 illustrates schematically in front view, a prior art printer device having a plurality of input trays for sheet media, and a plurality of output trays for sheet;

FIG. 5 illustrates schematically the known printer device of FIG. 4 showing a rear output tray and top output tray;

FIG. 6 illustrates schematically one example of a media path in a known printer device;

FIG. 7 illustrates schematically a novel printing system comprising a sending computer entity and a receiving printer device for printing documents double sided on media sheets according to a first specific method;

FIG. 8 illustrates schematically components of the novel printing system of FIG. 7 herein;

FIG. 9 illustrates schematically process steps for operation of the printing system of FIGS. 7 and 8, according to a specific method of the present invention;

FIG. 10 illustrates schematically one example of a ‘layout’ display view which may be displayed on a visual display device of the computer entity of the printing system of FIG. 7;

FIG. 11 illustrates schematically a ‘user dialogue’ display view which may be displayed on a visual display device of the novel printing system of FIG. 7;

FIG. 12 illustrates schematically one example of a printed media sheet containing instructions for further printing of a stack of media according to a specific embodiment of the present invention;

FIG. 13 illustrates schematically process steps carried out by a printer driver for preparing a print job for sending to a printer device according to a specific method of the present invention;

FIG. 14 illustrates schematically process steps for printing a document according to a specific method of the present invention;

FIG. 15 illustrates schematically a use model followed by a user of the printing system described with reference to FIGS. 7 to 14 herein;

FIG. 16 illustrates schematically process steps carried out at a host computer for sending a print job to a printer device according to a third specific implementation; and

FIG. 17. Illustrates schematically process steps carried out at a printer device according to the third specific implementation.

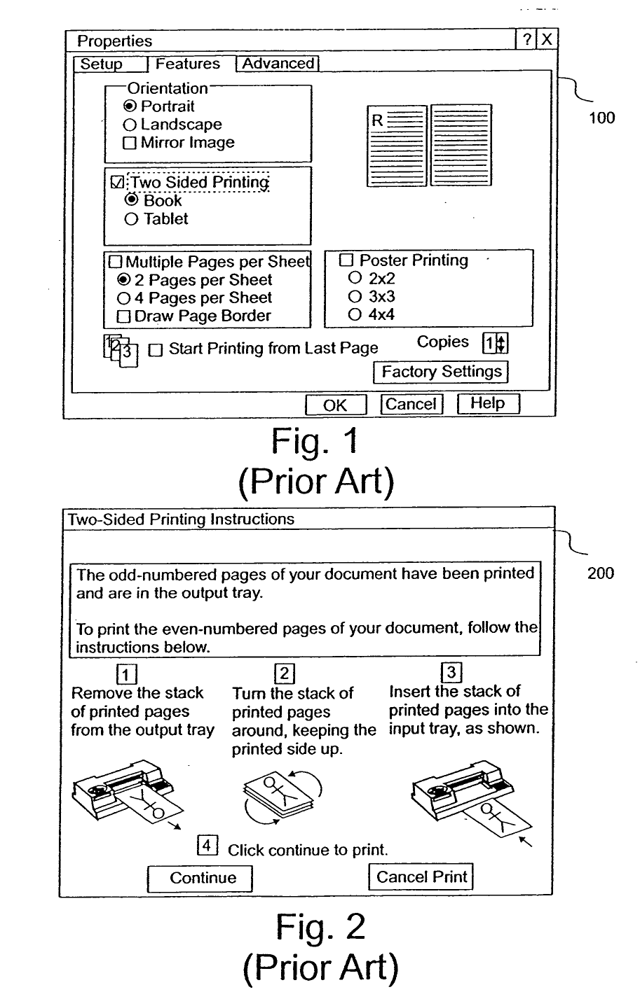

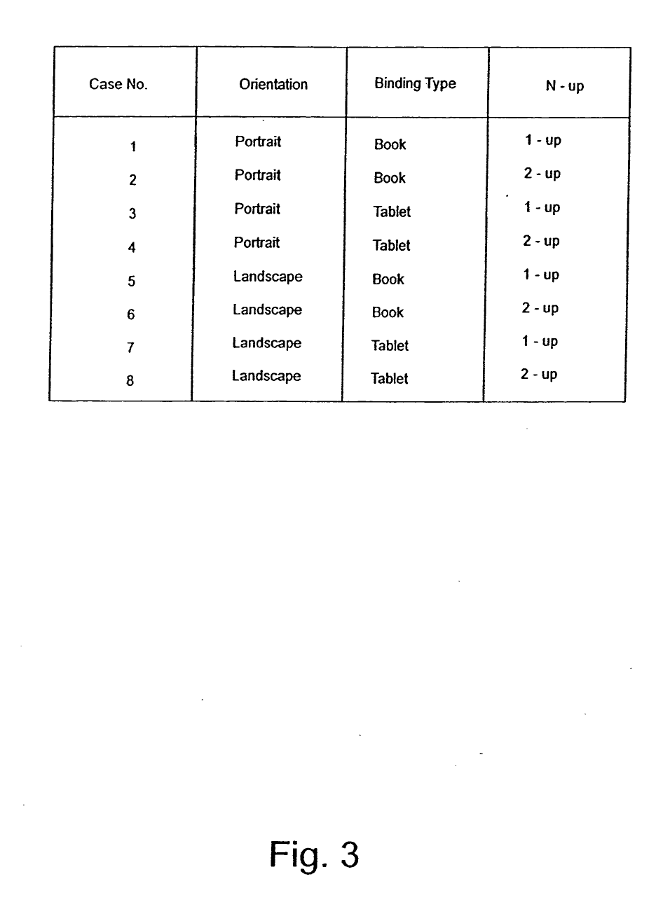

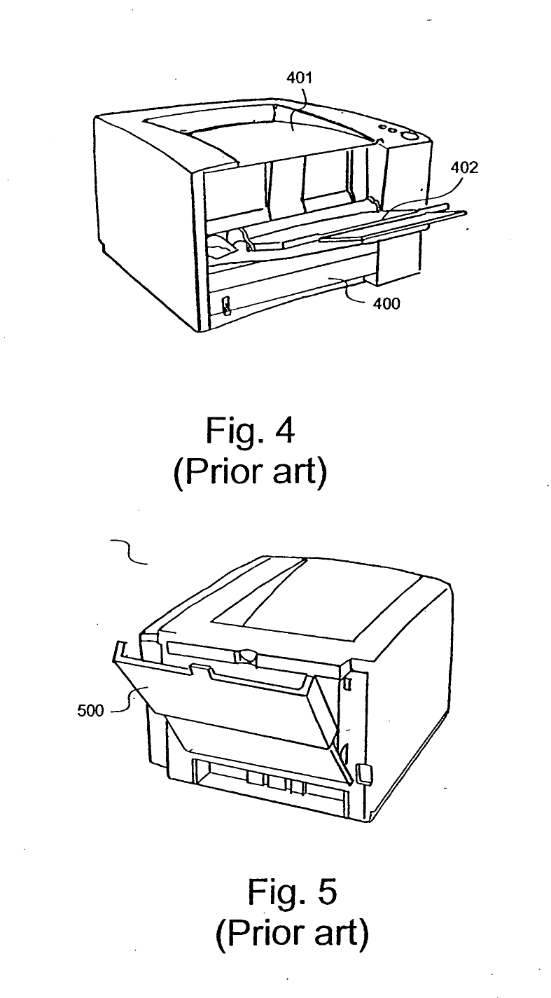

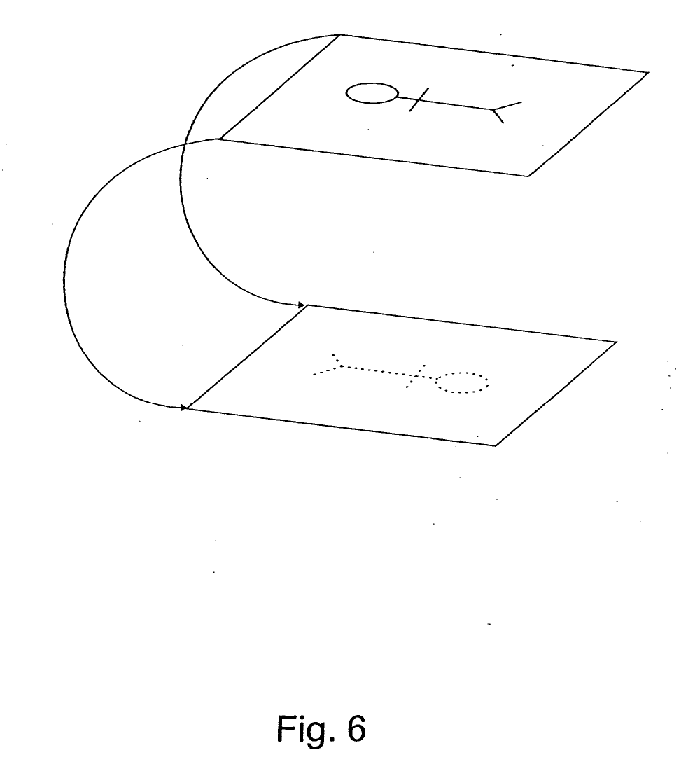

DETAILED DESCRIPTION OF A SPECIFIC MODE FOR CARRYING OUT THE INVENTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

In this specification, the term “sheet” is used to refer to one physical piece of print media, for example a sheet of paper, a sheet of acetate, a sheet of fabric or other print media, whether that print media is printed on no sides, one side or two sides.

In this specification, the term “side” is used to describe one side of a printed sheet of media.

In this specification, the term “document page” is used to refer to the concept of a page of information, for example text, drawings or the like, as used by a users application program. A document page can vary between different print applications as illustrated by the following examples. As a first example, in the known PowerPoint package, a “page” is a presentation slide and is oriented for screen display. When printed, the default orientation is to use landscape orientation to match a display screens presentation.

In a second example, in the known ‘Word’ processing application or other word processing applications, a “page” maps directly onto a printed sheet of media, and is generally presented in portrait format. However, users can define a landscape orientated page.

In a third example, in a known web browser, a “page” in this case a webpage, comprises a long flow of text and graphics with no implicit page breaks, and the user can scroll through the page. When the webpage is printed, the flow of text and graphics needs to be split into individual printable pages which will each fit onto a side of print media.

Specific implementations according to the present invention are concerned with printing of documents comprising a plurality of sheets of media, each sheet of media having two sides which can be printed on. An application generating a printable document can be sent to a remote printer device, which does not have an automatic duplexing function. A print application program resident on a sending computer entity can be used to format a document such that one or more pages are printed per side of sheet media, and the sheet media can be printed on two sides. The print application generates an additional user advice instruction which is printed by the printer device. The printer device operates to print a first set of sides of sheet media with a document. A human user reads the printed advice instructions, which tell a user how to enter the media sheets into an input tray of a printer device, so that the second, reverse sides of the sheet media can be printed. The printer application sends a print job to the printer device, which includes the user advice instructions, and which includes a pause instruction for pausing printing of a document between printing of a first set of sides of sheet media and a second set of sides of sheet media. This gives a user time to remove printed media sheets from an output tray of the printer device and replace those media sheets into an input tray of a printer device in a correct orientation according to the set of printed instructions, following which printing of the reverse sides of the media sheets occurs.

According to a specific implementation of the present invention, when printing a document in a manually assisted two sided printing mode, on printing a stack of print media sheets printed on a first side, there is printed information describing an orientation of how to place a stack of print media on a printers input tray for printing of the second sides of the sheets of print media.

In various implementations, the information can be printed either on the first side of any one or more of the sheets of print media, or in an alternative implementation, the information can be printed on a separate media sheet which is included in the stack of sheets of print media, for example at the end of the print run for the first sides.

For printer devices with a “C” shaped media path, the side of the media that is printed on in the first half of a manual-duplex print operation must be placed face up in an input tray of the printer device for the second half of the print operation, with the un-printed side hidden below.

The invention is not limited to printer devices having a “C” shaped media path, but can also be applied to printers having a different media path shape. Since a set of instructions are printed along with the first sides of printed media, this enables the specific methods herein to be used with network/remote printer features.

Three principal implementations are as follows.

In a first implementation, printing of information describing an orientation of a stack of print media is determined by a print driver component resident on a host computer device, and activation of printing of a reverse side of the media sheets is activated at the host computer.

In a second implementation, information as to the orientation of a stack of media sheets is generated by a print driver resident on a host computer, but activation of the printing of the second sides of the media sheets is activated at the printer device itself.

In a third implementation, there is no special re-formatting of the document at the host computer, and pages are sent sequentially numbered from the host computer to the printer device. However, the host computer sends the document with a ‘duplex on’ signal, so the printer device only prints alternate pages before pausing and allowing a user time to re-insert the media into the printer before printing the remaining intermediate pages.

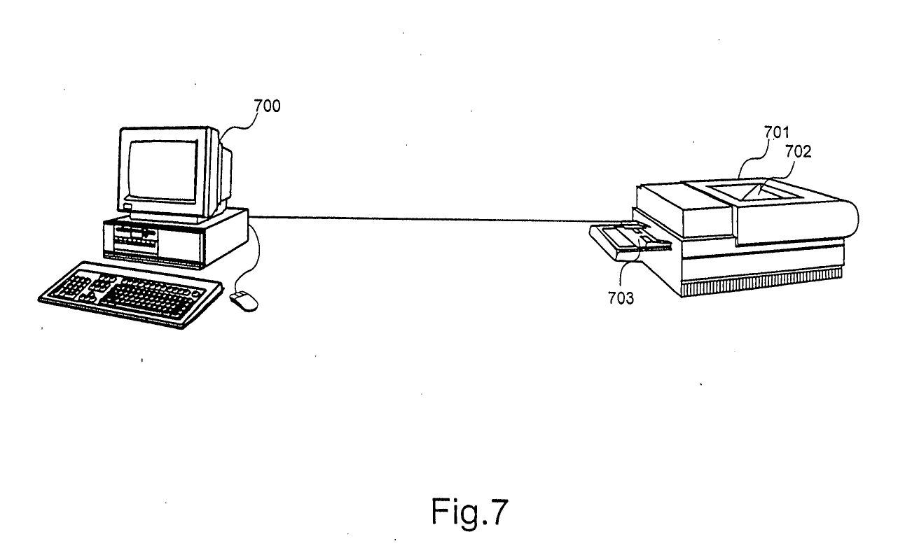

Referring to FIG. 7 herein, there is illustrated schematically a computer entity 700 and a printer device 701 adapted according to a specific embodiment of the present invention.

The computer device 700 hosts a print application capable of generating a document output. A user sends a document to print from the sending computer 500 to a selected printer device 701. The printer device may be remote from the sending computer entity 700, and there may be one or more intermediate computer entities between the sending computer entity and the printer device, through which a document sent to print may pass on its way to the printer. The printer device need not be within sight of the sending computer entity 700.

The printer device comprises an output tray 702, into which printed media sheets are deposited by a printer mechanism within the printer; and an input tray 503 into which a stack of media sheets can be loaded, for printing a reverse side of each media sheet.

The computer sends a print job to the printer device. The print job comprises a plurality of pages of information arranged in a data format comprising a plurality of first sides and a plurality of second sides; and a user information data, describing instructions to a human user for orientation of a set of media sheets for entry into a printer device. The computer also sends a pause command for pausing printing of said media sheets after a print operation of a set of first sides of said media sheets.

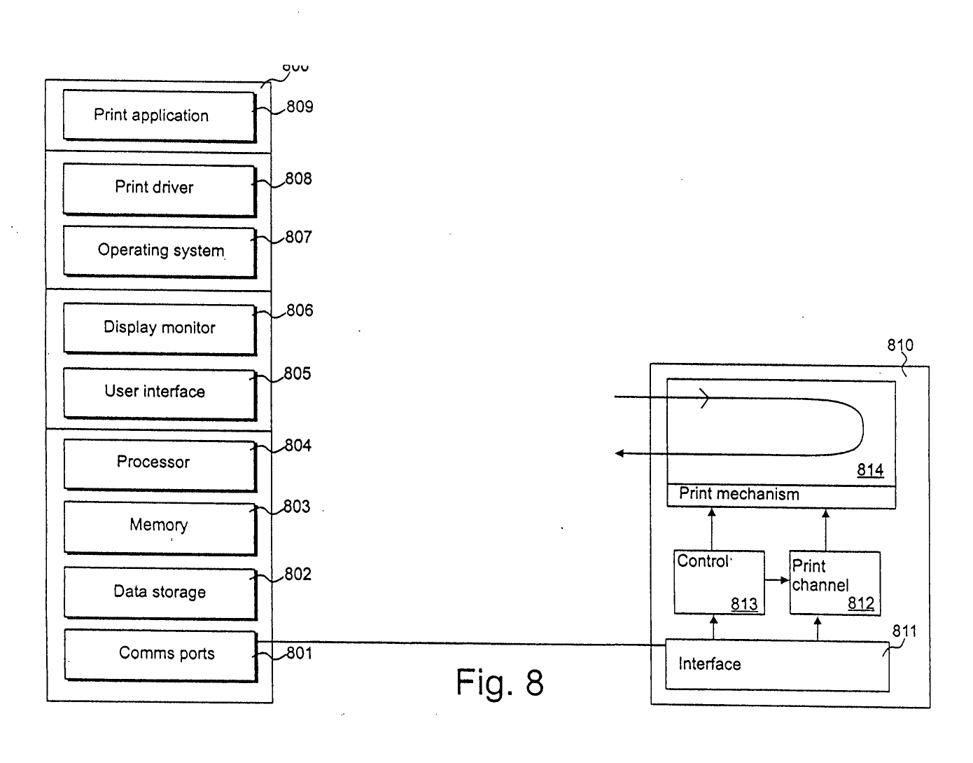

Referring to FIG. 8 herein, there is illustrated schematically components of the sending computer entity and printer device referred to in FIG. 7 herein.

Computer entity 800 comprises a communications port 801 for communicating with the printer device; a data storage device 802, for example hard disk data storage device; a memory device 803; a data processor 804 as is known in the art; a user interface 805 comprising a keyboard and pointing device; a display monitor 806 for displaying visual displays generated by a document application and a print driver; an operating system 807, which may be a known operating system; a print driver 808; and a document application 809 for generating documents to be printed.

The print driver is modified to perform a specific method according to the present invention for printing information concerning an orientation of sheet media at the printer device.

The print driver comprises a print application program for sending print instructions to the printer device. The print driver and application can be implemented as program code instructions for controlling a print system, said program code instructions comprising a component for generating a user instructions, said user instructions specifying an orientation for entering a set of media sheets into an input tray of a printer device, and a component for automatically activating printing of said user instructions along with printing of said media sheets.

The printer device 810 comprises: an interface 811 for receiving print jobs; a print channel 812 for sending print information to a print head; a controller 813 for controlling passage of sheet media and general operation of the printer device; and a print mechanism 813 for printing information to sheet media.

The example printer mechanism shown in FIG. 8 has a “C” shaped print media path, in which a sheet of media, e.g. paper placed face up on an input tray of the printer device is rotated and turned over, so that it exits the printer device having the side which was originally faced up pointing downwards in the output tray of the printer device.

In the general case, the media path may differ between different printer models. Some printer devices may have media paths in which a media sheet placed with a first side facing initially upwards in an input tray exits the printer device with the first side still facing upwards.

Print driver 808, which can be implemented in the form of program code instructions and loaded into the computer entity via a data storage media such as a CD-ROM disc, or downloaded over the internet, comprises a component for instructing the processor of the computer entity to generate printable data for printing instructions on a print media which are printed at the same time as a print job is sent from the computer entity to the printer device.

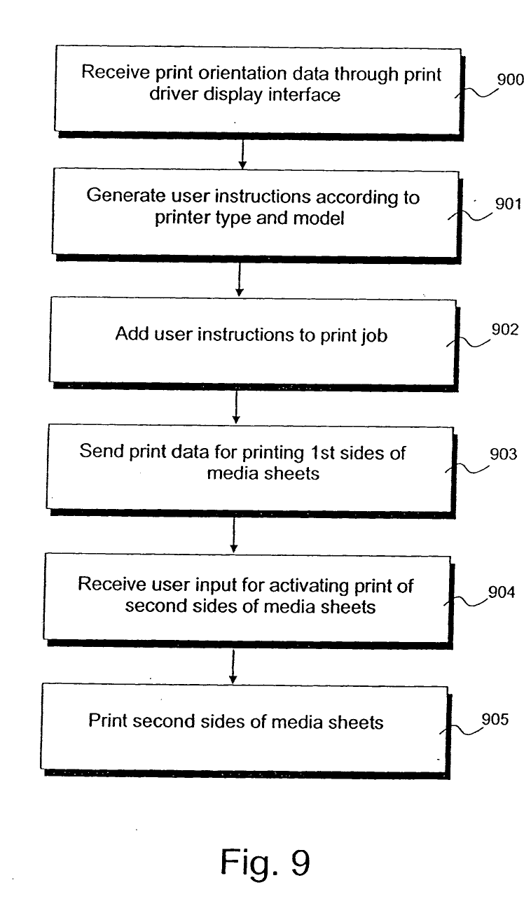

Referring to FIG. 9 herein, there is illustrated schematically process steps carried out by the print driver according to a specific method of the present invention.

A user generates a document for printing in a document generating application in known manner. The document is formatted in the document application into a plurality of pages. The user selects printing of the document, which activates the print driver. The print driver maybe specific to a single type and model of printer device or variants of that printer device.

The print driver generates a display view in the form of a user dialogue box through which the user can select printing options. Printing options may include a selection of portrait, landscape or mirror image orientations; two sided printing or single sided printing; printing in book format or tablet format; printing of one page per sheet or multiple pages per sheet, and whether poster printing is required and if so the poster format, whether two times two, three times three, or four times four; a number of copies to printed, and an option to start printing from a last page.

In process 900, the printer driver receives user instructions on the printing format via the display interface. In process 901, the print driver generates a set of printable instructions for physical handling of the media sheets, according to the printer type and model for which the print driver is designed. The print driver is pre-coded with printable instructions which are predetermined to suit the model and type of printer device, taking into account the changes in orientation of a sheet of media as it is transported through the print mechanism. In process 902, the print driver adds the printable user instructions to a print job for sending to the printer device. The instructions can be added as printed information in a header or footer of a document being sent for print, or to be included in a margin of the media sheets once they are printed. Alternatively, a set of instructions can be printed as a separate additional sheet to the printed document, to be added on to the end of the first print run when the first sides of sheet media are printed in the print job.

In process 903, the print data for printing the first sides of the media sheets is sent to the printer device, along with an extra print information for printing the user instructions, in one implementation, on an additional sheet of print media. In process 904, the print driver receives a user input, for activating printing of the second sides of the media sheets. At this stage, the user will already have removed the media sheets from the output tray of the printer, tidied them up and arranged them so that they are neatly stacked together, and places the media sheets in the input tray of the printer device according to the printed instructions. In process 905, the printer device is activated to print the second sides of the print media sheets.

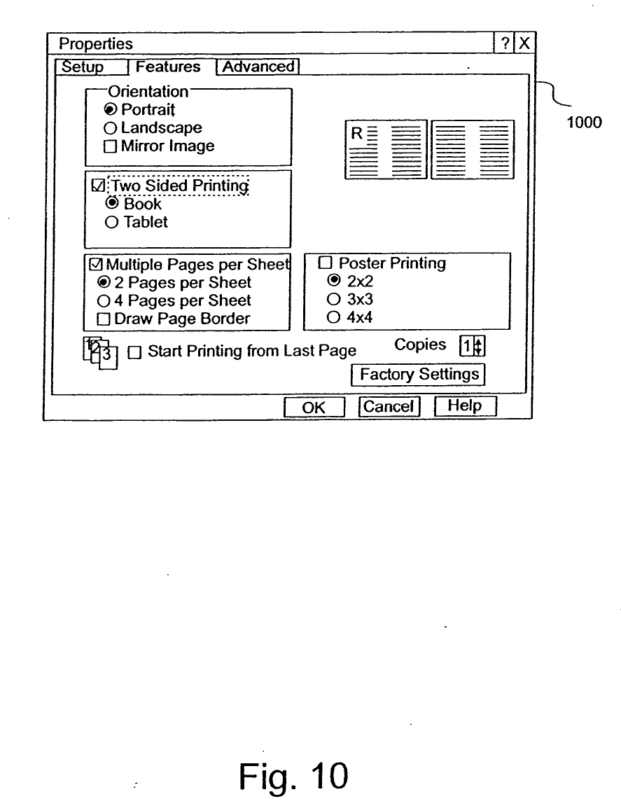

Referring to FIG. 10 herein, there is illustrated schematically one example of a dialogue box generated by the print driver to enable to a user to select printing options at the sending computer. In the example shown, the user selects portrait orientation, two sided printing and book bound, with two pages per side of media sheet.

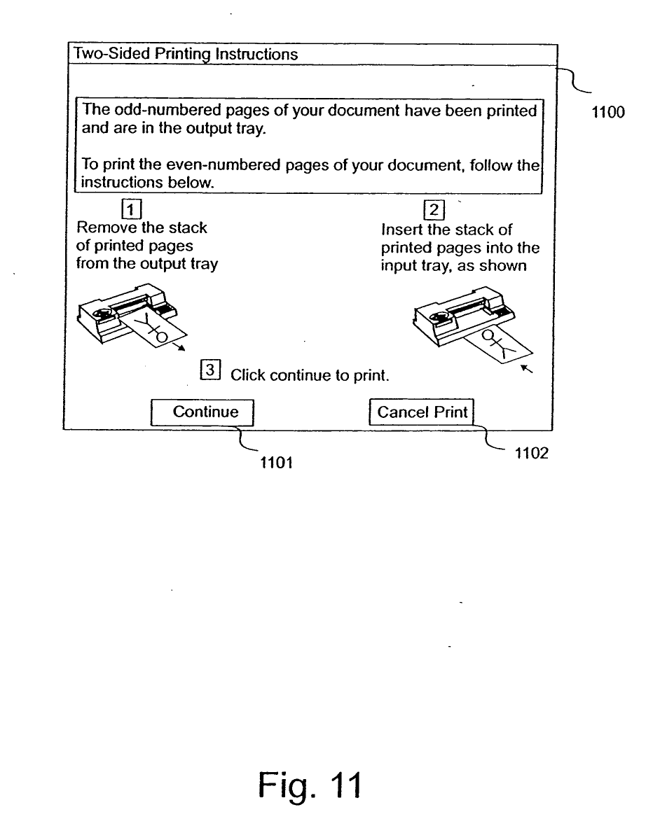

Referring to FIG. 11 herein, there is illustrated schematically a user dialogue display view 1100 generated in response to a user activating the layout view display view as described with reference to FIG. 10 herein. The user dialogue display comprises text and/or graphics instructions on how to place a stack of documents which have one side already printed, into an input tray of a printer device, in order to correctly orient the stack of media sheets for correct printing of the second sides. The display 900 also comprises a “Continue” icon 1101 which the user can activate once they have correctly placed the stack of media sheets in the input tray; and a “Cancel” icon 1102 for canceling the second part of the print operation in which the second sides of sheet media are printed.

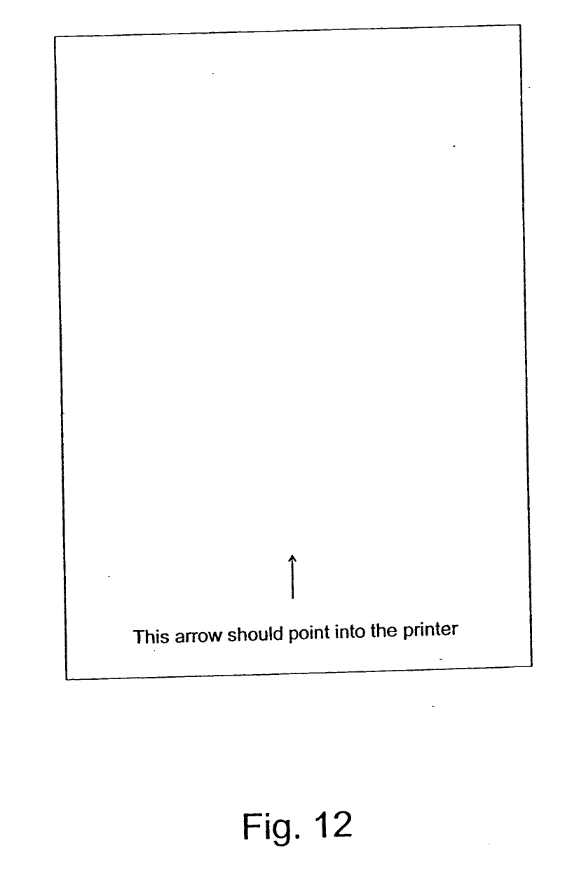

Referring to FIG. 12 herein, there is illustrated schematically a view of one side of a printed media sheet, having user instructions printed thereon. The user instructions contain text and/or graphics information printed onto a first side of a sheet of media, which inform a user in which orientation to place a stack of media sheets each having a first printed side in an input tray of a printer device.

There are various alternative implementations for carrying out processes 903 to 905 of the print process.

In one implementation, the sending computer may wait for the user to activate a “continue” icon presented on a printing instructions display view at the visual display monitor of the sending computer, to activate printing of the second sides of the media sheets. However, where the printer is remote from the sending computer, for example in a different room or along a corridor, this involves the user, after placing the stack of printed media sheets having one side printed in an input tray of the printer, returning to the sending computer in order to activate the “continue” icon to activate printing of the second sides of sheet media. The person then has to walk back to the printer in order to collect the stack of printed media sheets.

Alternatively, the printing instructions display shown in FIG. 10 herein can be sent to a host computer from which the printer device is operated, which need not be the same as the sending computer entity, and the printing instructions display view may be displayed at a host computer immediately adjacent the printer device.

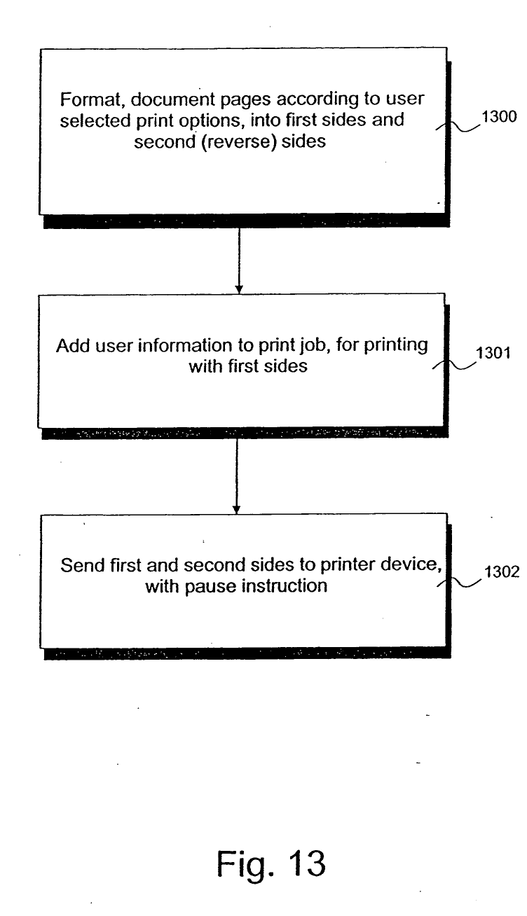

Referring to FIG. 13 herein, in another implementation, the user can activate printing of the second side of the media sheets at the printer device itself. In process 1300 the printer driver formats the document pages according to user selected print options which are selected via the layout of view displayed on the sending computers screen. The document is formatted into first sides and second sides. Depending upon the format selected, the first sides can contain odd pages, even pages or odd and even pages, as can the second sides. For example in the two sided book printing option with two pages per sheet as illustrated with reference to FIG. 10 herein, both odd and even pages appear on each side of the media sheets.

In process 1301, the printer driver adds user information to the print job for printing with the first sides. The user information as described herein before, comprises instructions to the user for orienting the stack of media sheets in the input tray of the printer. In process 1302, the printer driver sends the first and second sides of the document to the printer device, with a pause instruction, and including the user information. The user information can be added as a separate sheet to be printed after printing the first sides, or the user information can be incorporated within the printed first sides.

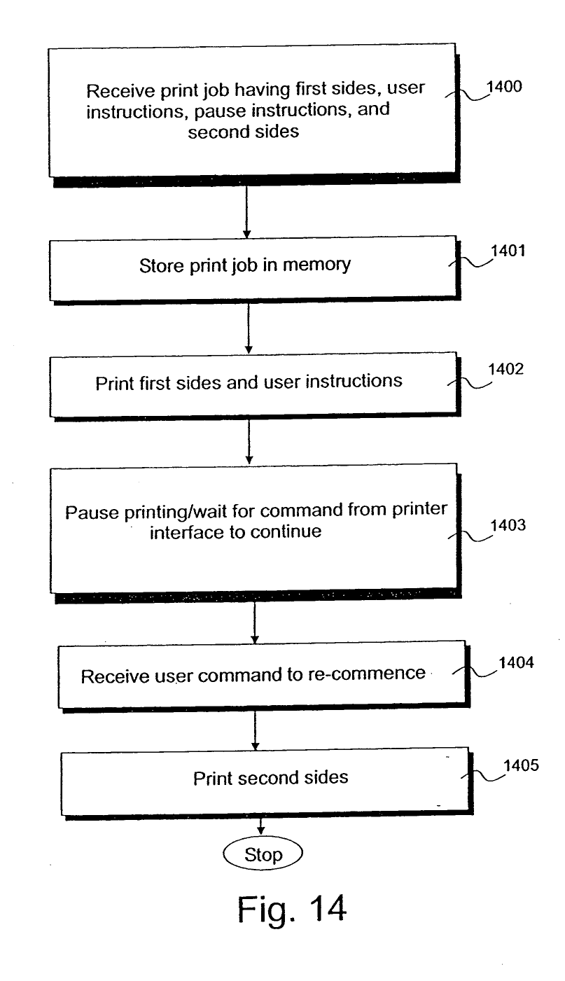

Referring to FIG. 14 herein, there is illustrated schematically processes carried out by a printer device according to a specific method of the present invention, for printing a document, where, once the printer device has received the document to be printed, the user does not have to return to a sending computer entity to activate printing of a set of second media sheets.

In process 1400, the printer device receives a print job comprising a set of first sides, a set of second sides, a set of user instructions, and the pause instruction for pausing the print job after printing of a set of first sides and after printing of a set of user instructions. In process 1401, the printer device stores the print job in memory. In process 1402, the printer device proceeds to print the first sides and the user instructions. After printing the first sides and user instructions, the printer pauses whilst it waits for a command to be input by a user via the printers interface. The proceed command can be entered for example by a user pressing a “Go” button provided on the printers casing, once the user has taken the stack of media sheets having their first sides printed from the output tray of the printer, tidied the sheets up, into a neat pile, and places the media sheets into the input tray of the printer in an orientation specified by the printed user instructions. In process 1404, once the printer device received a command from the user to recommence printing, then in process 1405 the printer device commences printing the second sides onto the stack of print media.

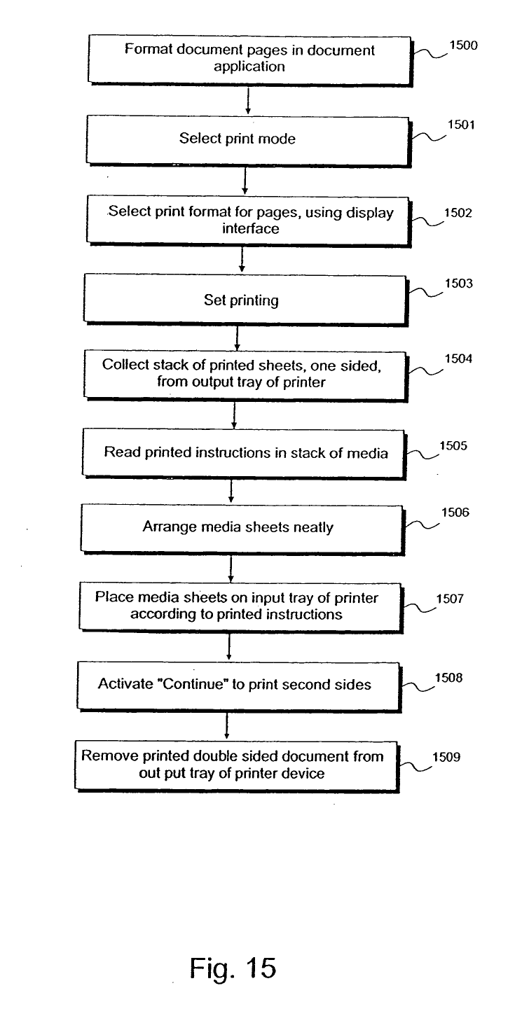

Referring to FIG. 15 herein, there is illustrated schematically a use model of a printing system according to a specific implementation of the present invention, followed by a user of the system. In process 1500, the user formats the document into a number of pages for printing using a known print application at the sending computer. In process 1501, the user selects a print mode, by activating a print menu or print icon displayed on a user interface of the sending computer in known manner. In process 1502, the user selects a print format for printing pages of the document using the display interface views generated by the print diver. In process 1503, the user activates printing of the document using a layout view display similarly as described with reference to FIG. 10 herein. The user places themselves near the printer device, which may be remote from the sending computer and collects a stack of media sheets, which have been printed on one side only from the output tray of the printer device in process 1504. In process 1505, the user identifies the user instructions for insertion of the stack of media sheets into the input tray of the printer device. The user may arrange the media sheets neatly in process 1506 prior to inputting the media sheets into the input tray of the printer device. In process 1507, the user places the media sheets on the input tray of the printer in accordance with the user instructions which have been printed during the print operation of the first sides. In process 1508, the user activates the printer device to continue printing the second sides. Activation can occur either at the sending computer via the user dialogue display view as exemplified by the view of FIG. 11 herein, or activation may occur by pressing a button on the printer device itself, in which case the user does not need to revert back to the sending computer entity. In process 1509, after the printer device has printed the second sides of the stack of print media, the user removes the printed double sided document from the output tray of the printer device.

In the third specific implementation, which may be suitable for a network printer device, a host computer sends a document as a set of consecutively numbered pages, with no document page re-ordering occurring. The host computer also sends a ‘DUPLEX=ON’ instruction to the printer device. The printer receives the document and prints firstly all odd sides, i.e. every second page from the page stream, pauses to give the user at the printer an opportunity to re-orientate the media sheets, and then proceeds to print even numbered sheets, after receiving an activation signal from the user. Thus, no re-ordering of the sheet order is needed by the host computer, and no special user interface is required on the host computer.

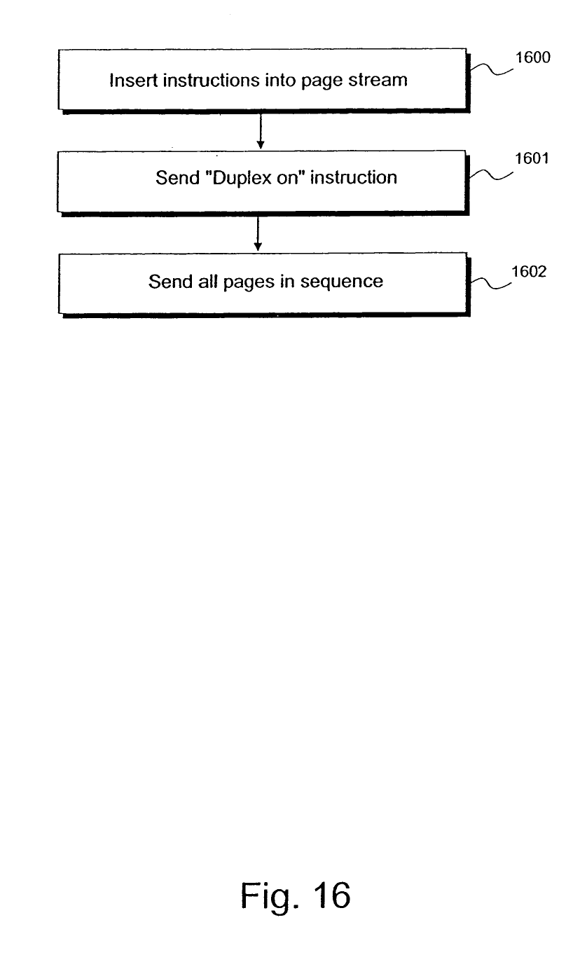

Referring to FIG. 16 herein, there is illustrated schematically a method of operation of the print driver at the host computer according the third specific implementation. In process 1600, the print driver inserts an instruction set to be printed on a document or as an extra sheet into a page stream of the document. The instruction set can be printed on the first page of the document, on the last page of the document, or on every page of the document, or can be printed as a separate sheet at the beginning, at the end, or at any intermediate place within the document. In process 1601, the printer device sends a ‘DUPLEX=ON’ instruction to the printer device, to set the printer device into a duplex mode. All pages are sent in sequence in process 1602, including, depending upon the variation of implementation, the separate instruction sheet, or the instructions incorporated into the document itself.

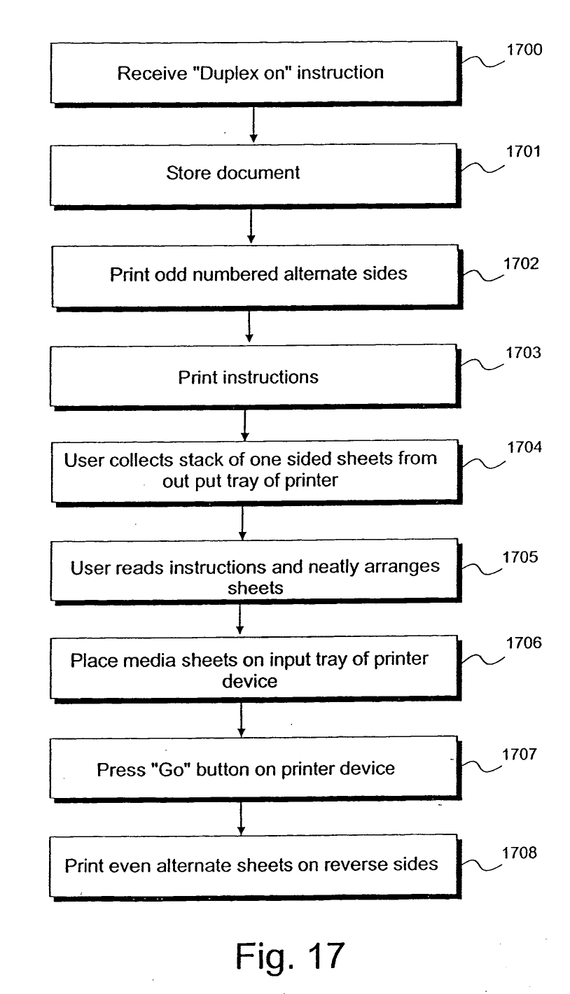

Referring to FIG. 17 herein, there is illustrated schematically process steps carried out by a printer device and a user according to the third specific implementation. In process 1700, the printer device receives a ‘DUPLEX=ON’ instruction, and adopts a pre-determined duplex mode in which the printer device is configured for printing firstly alternate pages within a receive document, pausing to wait for an instruction to proceed, and then printing the remaining alternately interleaved pages of a document. In process 1701, the printer device stores the incoming document. The incoming document has embedded within it, or as a separate sheet, a set of user instructions instructing a user for orientation of a first set of printed sides of media sheets once they are received in an output tray of the printer device. In process 1702, the printer device proceed to print a first set of alternate sheets of a document, for example odd numbered sheets. The printer device also prints a set of print instructions in process 1703, either as text on the alternate media sheets, or as a separate instruction sheet either at the beginning of the print or at the end of the print run.

In process 1704, the user picks up the media sheets from the printers output tray, which have one side of the document printed on. The user reads the instructions in process 1705. The instructions may be contained on a separate discreet extra sheet in addition to the document, or may be printed on a document itself. The user neatly collates the media sheets, and inserts them into an input tray of the printer device according to the instructions. The sheets may be inserted in to the same input tray as the media sheets originated from, or into a separate second input tray of the printer device, depending upon the instructions specified, and this may vary from printer device to printer device. In process 1707, the user activates a ‘GO’ button on the printer device and the printer device then proceeds to print the reverse side of the media sheets with the remaining alternating pages of the document which were interleaved with the first set of alternating pages, so that the resultant printed media sheets output into the output tray of the printer are printed double sided.

Where the document is sent from the host computer to the printer device as a page stream with all pages in order, and with a ‘DUPLEX=ON’ instruction, the printer driver does not need to know if the printer has a duplex or not. The print driver may ‘see’ a printer device as a normal non-duplex printer device, but nevertheless sends a ‘DUPLEX=ON’ signal. The printer may be configured to generate itself the instruction sheet, on receiving the ‘DUPLEX ON’ instruction and then pause printing. In this implementation, the printer device has functionality to recognize a ‘DUPLEX ON’ signal, and in response to a receiving ‘DUPLEX=ON’ signal to activate printing of alternate document pages to media sheets, pause before waiting for a ‘proceed’ or ‘go’ signal, and then upon receiving such signal, print the interleaved alternate document pages on the other sides of the sheets, which have been re-inserted by a user.

Specific implementations according to the present invention may have an advantage of allowing correct loading of a pile of media sheets by a user, and reducing errors and loss of time, media sheets and ink.

Specific implementations according to the present invention may allow two-sided printing of documents from a printer device which is positioned remotely from a sending computer device. Further, specific implementations may allow two-sided printing of documents where a document is sent over a network to a network printer, where the network printer does not have an automated duplexing mechanism.

1. A method of printing double sided documents on a printer device, said method comprising:
printing at least one first side of at least one media sheet in a single operation;
printing a set of user instructions for instructing a user to introduce said at least one media sheet into said printer device; and
printing at least one second side of said at least one media sheet.

2. A method of printing double sided documents on a printer device, said method comprising:
formatting said document into a form suitable for printing onto first sides of a plurality of media sheets in a single operation;
generating a set of user instructions for instructing a human user to manipulate said plurality of media sheets and enter said sheets into said printer device; and
printing said set of user instructions.

3. The method as claimed in claim 2, further comprising:
formatting said document into a form suitable for printing onto a set of second sides of said plurality of media sheets; and
printing said document onto said set of second sides of said plurality of media sheets.

4. The method as claimed in claim 2, comprising:
printing said document onto a set of second sides of said plurality of media sheets; and
activating said printing of said second sides in response to a user command input via a user interface of said printer device.

5. The method as claimed in claim 2, comprising:
printing said document onto a set of second sides of said plurality of media sheets; and
activating printing of said set of second sides in response to an activation signal input via a user interface at a computer entity.

6. A printing system comprising:
a computer entity capable of generating a print job;
a printer device for printing a plurality of sheets of print media according to said print job;
said printing system operable for:
printing first sides of a set of said print media sheets; and
printing a set of instructions for entering said set of printed print media sheets into said printer device for printing second sides of said media sheets.

7. The printing system as claimed in claim 6, further operable for:
printing said second sides of said plurality of print media sheets in response to a signal input by a human user.

8. The printing system as claimed in claim 6, further operable for:
printing said second sides of said plurality of print media sheets in response to a signal input by a human user, wherein said input signal is input via a graphical user interface.

9. The printing system as claimed in claim 6, further operable for:
printing said second sides of said plurality of print media sheets in response to a signal input by a human user, wherein said input signal is received via a printer user interface positioned on said printer device.

10. A print job comprising:
a plurality of pages of information arranged in a data format comprising a plurality of first sides and a plurality of second sides; and
a user information data, describing instructions to a human user for orientation of a set of media sheets for entry into a printer device.

11. The print job as claimed in claim 10, further comprising a pause command for pausing printing of said media sheets after a print operation of a set of first sides of said media sheets.

12. Program code instructions for controlling a print system, said program code instructions comprising:
a component for generating a user instructions, said user instructions specifying an orientation for entering a set of media sheets into an input tray of a printer device; and
a component for automatically activating printing of said user instructions along with printing of said media sheets.

13. The program code as claimed in claim 12, configured so as to print said user instructions on a separate sheet of media which is additional to a set of media sheets used for printing of a document.

14. The program code instructions as claimed in claim 12, operable for printing said user instructions on a same media sheet as used for printing a document sent for printing.

15. A printed instruction sheet containing a set of instructions advising a human user on orientation of a stack of print media, for entering said stack of print media into an input tray of a printer device.

16. An electronic print job data comprising data for printing an instruction sheet as claimed in claim 15.

17. A printing system operable for:
printing first sides of a set of print media sheets; and
printing a set of instructions for entering said set of printed print media sheets into a printer device for printing second sides of said media sheets.

18. The printing system as claimed in claim 17, further operable for:
printing said second sides of said plurality of print media sheets in response to a signal activated by a human user.

19. A method for printing two sided documents, said method comprising:
formatting a plurality of document pages in a form suitable for printing on a plurality of sheets of print media;
printing first sides of said plurality of sheet media with said document;
printing instructions for handling of said plurality of sheets of media;
manipulating said plurality of sheets of media in accordance with said set of printed instructions;
placing said set of media sheets into an input tray of a printer device; and
printing second sides of said plurality of media sheets with said document.

20. A method of sending a print job for double sided printing on a printer device, said method comprising:
sending an DUPLEX ON instruction signal to said printer device, indicating a duplex printing mode;
sending a user instruction for instructing a user to manipulate at least one media sheet at said printer device; and
sending a document file to said printer device for printing.

21. A method of printing a received print job for double sided printing of a document on a printer device, said method comprising:
receiving a document file at said printer device, said document file comprising a set of consecutive pages;
receiving a DUPLEX ON instruction signal at said printer device, instructing said printer device to adopt an interrupted printing mode for printing said a document;
in response to said DUPLEX ON instruction printing a first set of pages of said document on first sides of said media sheets;
receiving a user instruction for instructing a user to manipulate at least one media sheet at said printer device;
printing said user instructions on at least one media sheet; and
printing a second set of pages of said document on second sides of said media sheets, said second set of sides being alternating with said first set of sides.
